(19) United States
(12) Patent Application Publication
(10) Pub. No.: US 2008/0214726 A1
(43) Pub. Date: Sep. 4, 2008

(54) Polymeric Materials

(75) Inventors: David J. Freeman, Cleveland (GB); Derek J. Irvine, Cleveland (GB); Jane Kitching, Cleveland (GB); Stephen C. Rogers, North Yorkshire (GB)

Correspondence Address: JONES DAY, 222 EAST 41ST ST, NEW YORK, NY, 10017, US

(73) Assignee: Croda International Plc, Goole, North Humberside (GB)

(21) Appl. No.: 11/667,495

(22) PCT Filed: Nov. 2, 2005
(86) PCT No.: PCT/GB05/04232

§ 371 Date: Nov. 5, 2007

(30) Foreign Application Priority Data
Nov. 10, 2004 (GB) 0424811.8

(51) Int. Cl. C08F 220/60; C08F 226/06

(52) U.S. Cl. 524/555; 526/307.2; 526/307.3; 526/260; 526/264; 526/263

(57) ABSTRACT

Copolymers, desirably having a molecular weight of from 500 to 20000, of aminoesters or aminoamides of (meth)acrylic acid and (meth)acrylamides at a molar ratio of from 10:1 to 60:1, particularly from 12:1 to 50:1 and especially about 20:1, can act as gas hydrate inhibitors in water containing hydrocarbon gas streams. Desirably the aminoesters or aminoamides are N-alkyl-amino(esters or amides) in particular of the formula (I): H₂C═CR¹ C(O)XR²NR³R⁴ (I) where R¹, R², R³, R⁴ and X have defined meanings and the (meth)acrylamides are of the formula (II): H₂C═CR⁶C(O)NR⁷R⁸ (II) where R⁶, R⁷ and R⁸ have defined meanings. Methods of treating gas water mixtures using the copolymers to inhibit gas hydrate formation are described.

This invention relates to polymers, particularly copolymers of aminoesters of (meth)acrylic acids and (meth)acrylamides, which can act as gas hydrate inhibitors, and to methods of inhibiting gas hydrate formation using them.

In high pressure handling of hydrocarbon gases, particularly C₁ to C₄ hydrocarbons, particularly methane and/or ethane, but also sometimes propane, n-butane and/or iso-butane, which may be mixed with N₂, H₂S and/or CO₂, and especially in transportation e.g. in pipelines, of a gas/water mixture, common when water is co-produced with the gas, solid gas hydrates may crystallise, particularly at ground temperatures in polar or near polar zones (especially in winter) e.g. typically from 15° C. to −8° C., or at seabed temperatures, especially on the deep seabed where temperatures are typically 3° C. to 4° C. Such solid gas hydrates can impede or even block movement of the hydrocarbon gas with damaging effects economically as, once formed, they are difficult to remove especially in areas that are difficult to access e.g. undersea pipelines. Gas hydrates may be formed onshore when, for example, the ambient air temperature is low and equipment, especially pipelines, are not buried, or are not fully insulated or heated.

Where such gas hydrate formation is likely, it is common practice to add inhibitors of gas hydrate formation to the hydrocarbon stream. Historically, inhibitors e.g. alcohols, such as methanol, or glycols such as mono-, di- or tri-ethyleneglycol, have been used to reduce the (equilibrium) temperature at which the gas hydrate crystallises. To be effective the amount of such inhibitors needs to be relatively high and this reduces the effective carrying capacity of the pipeline, and requires facilities to separate the inhibitor from the gas (for inhibitor recirculation and to avoid contamination of the downstream gas flow).

More recently, inhibitors affecting the speed of crystallisation or the form of crystal have been used. Such so-called kinetic inhibitors have little effect on the equilibrium temperature of crystallisation, because they are used at relatively low levels, but they do slow crystallisation or change the crystal form of the hydrate so that during transport in the pipeline, blockages do not occur. Various materials have been suggested as kinetic gas hydrate inhibitors including polymers, particularly copolymers based on poly(N-vinylpyrrolidone) e.g. WO 94/12761 A and U.S. Pat. No. 5,432,292 describe the use of a terpolymer of N-vinylpyrrolidone, N-vinylcaprolactam and dimethylaminoethyl methacrylate sold under the trade name Gaffix VC-713 as a gas hydrate inhibitor. Further such polymers are a range of materials described in patents of Institut Français du Pétrole (IFP) e.g. EP 0807678 A1 and its equivalent U.S. Pat. No. 5,981,816. Included in these material are polymers based on monomers of the formula: H₂C═CR—C(O)X—X′—NR′R″, where: R is H or Me; X is —O— or —NH—; X′ is divalent alkylene particularly C₁ to C₃ alkylene; R′ is H, Me, Et or i-Pr; and R″ is H, Me or Et e.g. dimethylaminoethylmethacrylate (DMAEMA). The possibility of using copolymers e.g. having monomer molar ratios 10:90 or 30:70 is generally described and a copolymer of DMAEMA and acrylamide at a monomer molar ratio of 10:90 is exemplified.

Such kinetic gas hydrate inhibitors have the advantage that they can produce useful reductions in the practical temperatures at which gas hydrate crystallisation occurs in a way that is likely to block pipes at relatively low levels of addition to the gas stream.

This invention is based on our finding that copolymers of aminoesters or aminoamides of (meth)acrylic acids and (meth)acrylamides having relatively low (meth)acrylamide content can act as effective gas hydrate inhibitors.

The present invention accordingly provides a gas hydrate treatment material which comprises a copolymer of at least one aminoester or aminoamide of (meth)acrylic acid and at least one (meth)acrylamide in which the residues of the (meth)acrylamide(s) are present at a molar ratio of from 10:1 to 60:1.

Particularly the invention provides a gas hydrate treatment material which comprises a copolymer of at least one N-alkylamino(ester or amide) of (meth)acrylic acid and at least one (meth)acrylamide in which the residues of the (meth)acrylamide(s) are present at a molar ratio of from 10:1 to 60:1.

Specifically the invention provides a gas hydrate treatment material which comprises a copolymer of at least one N-alkylamino(ester or amide) of (meth)acrylic acid of the formula (I):

H₂C═CR¹C(O)XR²NR³R⁴ (I)

where

R¹ is H or methyl;

R² is a C₁ to C₁₀ hydrocarbyl group;

R³ is H or a C₁ to C₁₀ hydrocarbyl group;

R⁴ C₁ to C₁₀ hydrocarbyl group; or

R³ and R⁴ together with the N atom to which they are attached form a 5-, 6- or 7-membered heterocyclic ring; and

X is —O— or —NR₅—, where R₅ is H or a C₁ to C₁₀ hydrocarbyl group;

and at least one (meth)acrylamide in which the residues of the (meth)acrylamide(s) of the formula (II):

H₂C═CR⁶C(O)NR⁷R⁸ (II)

where

R⁶ is H or methyl; and

R⁷ and R⁸ are each independently H or a C₁ to C₁₀ hydrocarbyl group; or

R⁷ and R⁸ together with the N atom to which they are attached form a 5-, 6- or 7-membered heterocyclic ring;

are present at a molar ratio of from 10:1 to 60:1.

The invention includes a method of treating gas water mixtures which are susceptible to the formation of gas hydrates with a copolymer of at least one aminoester of (meth)acrylic acid and at least one (meth)acrylamide in which the residues of the (meth)acrylamide(s) are present at a molar ratio of from 10:1 to 60:1, particularly a copolymer of copolymer of at least one N-alkylamino(ester or amide) of (meth)acrylic acid of the formula (I) as defined above and at least one (meth)acrylamide in which the residues of the (meth)acrylamide(s) of the formula (II) as defined above.

In the copolymers of the invention, where the co-monomers include monomers of the formulae (I) and (II), it is desirable that R² is a C₂ to C₈, particularly a C₂ to C₄ alkylene group; R³ and R⁴ are each independently, particularly C₁ to C₄ alkyl groups or, where the group —NR³R⁴ is a heterocyclic ring, an N-pyrrolidino, N-piperidino, N-morpholino, N-piperazino or N-caprolactamyl group; R⁵ is desirably H; and R⁷ and R⁸ are each desirably H or a C₁ to C₄ alkyl group, or, where the group —NR⁷R⁸ is a heterocyclic ring, an N-pyrrolidino, N-piperidino, N-morpholino, N-piperazino or N-caprolactamyl group.

There are two specific sub-types of compounds of the invention: copolymers where the amino(meth)acrylic monomer is either an amino ester of (meth)acrylic acid or an aminoamide of (meth)acrylic acid. The invention includes each of these sub-types of copolymer and their use as gas hydrate inhibitors. Specifically the invention includes copolymers where the respective monomers are an aminoester of the formula (Ia) and/or an aminoamide of the formula (Ib) as set out below:

a) where the monomer of the formula (I) is an aminoester then it is desirably of the formula (Ia):

H₂C═CR¹C(O)OR²NR³R⁴ (Ia)

where R¹, R², R³ and R⁴ are as defined for formula (I); and

b) where the monomer of the formula (I) is an aminoamide then it is desirably of the formula (Ib):

H₂C═CR¹C(O)NR⁵—R²NR³R⁴ (Ib)

where R¹, R², R³ R⁴ and R⁵ are as defined for formula (I).

The invention includes copolymers including both an aminoester of the formula (I) and an aminoamide of the formula (Ib), but more usually only one of these monomers will be included. Specifically and particularly the copolymer of the invention is a copolymer of at least one (meth)acrylic acid N-alkylaminoester of the formula (Ia) and at least one (meth)acrylamide.

Other monomers may be included in the copolymers provided that they do not substantially interfere with the desired gas hydrate inhibiting properties of the copolymers of the invention. In particular, it is desirable that the inclusion of monomers that tend to make the copolymer water insoluble, notably (meth)acrylic hydrocarbyl esters e.g. methyl methacrylate and butyl acrylate and methacrylate, are not included in substantial amounts as this will tend to reduce the water solubility of the copolymers. Thus if such monomers are included the proportion is desirably not more than about 5 mol %, more desirably not more than 3 mol % and particularly less than 1 mol %.

The relative proportions of the amino (meth)acrylate or amino (meth)acrylamide and (meth)acrylamide monomers used in making the copolymers of the invention are from 10:1 to 60:1, particularly from 12:1 to 50:1, desirably from 15:1 to 30:1, and especially about 20:1. At ratios having proportions of amino(meth)acrylate or amino(meth)acrylamide of greater than about 30:1 and particularly greater than about 60:1 the copolymers do not give significant improvements as compared with the amino(meth)acrylate or amino(meth)acrylamide homopolymer and at ratios less than about 12:1, particularly about 10:1, generally show a fall off of effectiveness as compared with optimum materials within the overall ratio range.

Desirably the copolymers of the invention have a number average molecular weight (Mₙ) of from 500 to 20000, more usually from 1000 to 10000 and desirably from 1500 to 5000. Molecular weights lower than about 1000, particularly lower than about 500 may lead to relatively high residual monomer levels which can have disadvantageous effects on toxicity and molecular weights higher than about 10000, particularly higher than about 20000, are less effective materials. The reasons for the lower effectiveness is not clear but may be related to the tendency of higher molecular weight copolymers to attach to multiple gas hydrate proto crystals, thus tending to promote aggregation and crystallisation.

In the copolymers of the invention, desirably the molecules contain an average of from 0.5 to 2.5, particularly from 0.7 to 1.5 and especially from 0.8 to 1.3 of residues of the (meth)acrylamide monomer. Generally the best results have been obtained where the proportion of the (meth)acrylamide monomer gives an average of about 1 (meth)acrylamide residue per copolymer molecule.

The copolymers of the invention can be made by conventional synthetic methods. A particularly convenient method is free radical polymerisation in bulk monomer or in solution in a suitable solvent e.g. a glycol ether, particularly an alkoxyethanol such as 2-butoxyethanol. The reaction will usually be initiated by a suitable initiator typically an azo initiator e.g. 2,2-azobis-iso-butyronitrile (AIBN) or 2,2′-azobis(2-methylbutyronitrile) (AMBN), or a peroxy initiator e.g. benzoyl peroxide or ammonium or potassium persulphate. The reaction can be started by increasing the temperature to promote initiator cleavage e.g. to temperatures from 60 to 150° C., more usually from 100 to 130° C. e.g. about 100° C. At these temperatures the polymerisation reaction is rapid, typically being complete for any particular chain within a few minutes—comparable in time to a few half lives of the initiator. To maintain control over the reaction, in particular to prevent runaway reaction, it is appropriate to meter the initiator into the reaction mix (held at reaction temperature) over a period of from a few tens of minutes to a few hours. Conveniently the (meth)acrylamide monomer can also be metered in over this period and may be premixed with the initiator, of course, keeping this mixture cool prior to introduction into the hotter reaction mix. The monomers used are susceptible to polymerisation and may be supplied with or stored in contact with polymerisation inhibitors such as hindered phenol antioxidants. Generally, the reaction runs to completion without undue difficulty and the product is the copolymer and is usable without purification.

The copolymers of the invention are typically (if desired after removal of the reaction solvent or medium) viscous yellow liquids. Solutions in e.g. alcohols, glycols or glycol ethers, are similar, though less viscous than the neat polymer.

In use as gas hydrate inhibitors, the copolymers of the invention may be formulated with various materials. In particular, suitable solvents may be used to provide the inhibitors at a concentration suitable for addition to a hydrocarbon gas stream, particularly by metered addition. Typically such solvents are low molecular weight relatively hydrophilic solvents such as alcohols such as C₁ to C₆ alkanols e.g. methanol, ethanol or isopropanol, glycols such as C₂ to C₆ glycols e.g. ethylene or propylene glycol, or corresponding di- or tri-glycols e.g. diethylene or triethylene glycol, or glycol ethers particularly alkoxyalkanols, e.g. C₁ to C₆ alkoxy C₂ to C₄ alkanols such as 2-butoxyethanol. Generally, among such solvents, monohydric materials are preferred as glycols tend to give more viscous solutions which may be inconvenient to handle or use. The use of such solvent may provide a minor additional benefit by reducing the crystallisation temperature of the gas hydrate under the treatment conditions. The concentration of the copolymer inhibitors of the invention in such a solvent will typically be from 1 to 80%, more usually from 2 to 60% and desirably from 5 to 50% e.g. about 40%, by weight of the solution.

The copolymer used as a gas hydrate inhibitor is generally incorporated into the stream to be treated at a concentration of 0.05 to 5%, more usually more usually from 0.1 to 2% desirably from 0.2 to 1% and commonly about 0.5%, by weight with respect to the quantity of water in the stream. The use of lower amounts of copolymer generally gives little inhibition of gas hydrate formation and higher levels are expensive and do not provide additional benefit. Within the above ranges, when the inhibitors are provided in solution then the amount of solvent added to the gas stream will typically be from 0.5% to 20%, particularly from 1% to 10% by weight, of the water in the fluid being treated.

Other additives may be included in the formulation used to treat the hydrocarbon gas stream and examples include:

i corrosion inhibitors, particularly film forming corrosion inhibitors such as dimer and trimer fatty acids (polymerisation products of unsaturated fatty acids such as oleic acid), phosphite esters, complex fatty amides and imidazoline inhibitors, typically used at levels from 1 to 100, more usually 5 to 80, desirably 15 to 60, and commonly about 30, ppm by weight of the total (water containing) hydrocarbon gas stream;

ii wax dispersants such as ethylene vinyl acetate copolymers or low HLB (hydrophile/lipophile balance) non-ionic surfactants such as glycerol mono-fatty acid esters particularly glycerol mono-oleate, and sorbitan mono-fatty acid esters, particularly sorbitan mono-oleate, typically used at levels from 50 to 5000, more usually 100 to 1000 , and commonly about 500, ppm by weight of the total (water containing) hydrocarbon gas stream;

iii asphaltene dispersants, such as the reaction products of long chain (particularly polyisobutylene e.g. C₃₀ to C₁₀₀) substituted succinic acid or anhydride with alkanolamines such as di- or tri-ethanolamine, sulphonic acid dispersants e.g. alkaryl sulphonic acids such as dodecylbenzene sulphonic acid, or resin dispersants such as alkylphenol formaldehyde dispersants typically used at levels from 50 to 5000, more usually 100 to 1000 , and commonly about 500, ppm by weight of the total (water containing) hydrocarbon gas stream;

iiii scale inhibitors such as sodium polyacrylates or phosphonate inhibitors, typically used at levels from 5 to 100, more usually 10 to 50, and commonly about 20, ppm by weight of the total (water containing) hydrocarbon gas stream.

The nature of these further additives means that they can interact and possibly interfere with one another if included in the same formulation. Accordingly it is unlikely that the gas hydrate inhibitors of the invention will be formulated with more than one such further additive. Of course, further such additives may be used on the same hydrocarbon gas stream, but will usually be added separately to minimise or avoid interference. Accordingly the invention includes a gas hydrate inhibition formulation which includes:

a a copolymer of the invention, particularly a copolymer of at least one N-alkylamino-(ester or amide) of (meth)acrylic acid of the formula (I) as defined above and at least one (meth)acrylamide in which the residues of the (meth)acrylamide(s) of the formula (II) as defined above; and

b at least one of (but usually not more than one of) a corrosion inhibitor, a wax dispersant, an asphaltene dispersant or a scale inhibitor.

The gas hydrate inhibitor, usually in solution and possibly formulated with other additive(s), will usually be added to a water containing hydrocarbon gas stream by metered flow addition, typically using a pump and flow line to introduce the inhibitor formulation into the stream. If addition of multiple additives which may be incompatible if co-formulated is desired then multiple addition pumps and flow lines to separate points in the stream being treated will typically be used. The introduction of such additives to hydrocarbon gas streams is typically carried out as close to the source of the stream as is practical. For land based production wells, it will usually be at or near the well head, for land based pipelines then (further) addition may be done at or near the start of the pipeline. For marine production wells, addition will usually be done at the subset wellhead to provide flow protection between the wellhead and the sea based production rig.

The following Examples illustrate the invention. All parts and percentages are by weight unless otherwise indicated.

Materials

Monomers—Amino acrylates (AmAc)

AmAc1 dimethylaminoethylmethacrylate (DMAEMA)

Monomers—Acrylamides (AcM)

AcM1 acrylamide (M)

AcM2 methacrylamide (MA)

AcM3 N,N-dimethylacrylamide (NNDMA)

Other Materials

AMBN 2,2′-azobis(2-methylbutyronitrile) free radical polymerisation initiator Vazo 67 ex DuPont

The gas used in testing is a mixture having the following composition:

| Component | concn (mol %) | Component | concn (mol %) |
|---|---|---|---|
| Nitrogen | 1.75 | i-Butane | 0.62 |
| Carbon dioxide | 1.36 | n-Butane | 1.12 |
| Methane | 79.29 | i-Pentane | 0.2 |
| Ethane | 10.84 | n-Pentane | 0.19 |
| Propane | 4.63 | | |

Test Method(s)

Copolymer Molecular Weight

was measured using gel permeation chromatography against a polymethylmethacrylate (PMMA) standard, using a 0.5% solution of triethylamine in THF as eluant with results given as the number average molecular weight (Mₙ) and polydispersity (Pdi).

Residual Monomer

The level of residual aminoacrylate monomer in the product co-polymer was measured by HPLC using an internal standard. Results are given in weight % (Resid. AmAc (%)).

Gas Hydrate Inhibition Testing

was carried out in cells made from individually grown sapphire crystals with their centres bored out to provide 32 ml test volume. The cells are jacketed in stainless steel, with two view windows. The test rig uses 4 identical cells held generally horizontally in a rocking frame that can be immersed in a water bath. Each cell has a stainless steel ball bearing that rolls along the cell bore as the cell rocks to provide agitation between the liquid and gas phases. The bore of each cell is connected to a manifold enabling pressurisation with the test gas.

10 ml of test solution, usually containing 0.5% by weight active gas hydrate inhibitor in demineralised water, is introduced into the test cell, which is sealed and connected to the manifold using a flexible hose and the rocking frame lowered into the water bath at approximately 20° C. The cells are then charged with the test gas (composition given above) to about 60 bar pressure and then sealed. When all four cells are charged the test run begins with the cells being immersed in the water bath and gently rocked while the water bath is cooled at a rate of 4° C. per hour to about 2° C. and then warmed gently to a holding temperature of 4° C. (corresponding approximately to average seabed temperature). The pressure and temperature within each cell is monitored and plotted to enable the evaluation of the inhibitors in terms of the sub-cooling achieved.

The pressure temperature plots at near ambient temperature, generally take the form of an approximately straight line having a positive gradient i.e. higher pressures correspond to higher temperatures, determined by thermal expansion and water solubility of the test gas. As the temperature is reduced, a point is reached where gas hydrate begins to form and further reductions in temperature lead to increased hydrate formation. As the hydrate has a much higher density than the gas, the slope of the pressure temperature plot increases i.e. there is a steeper decrease of pressure with temperature. As plotted this gives the appearance of two straight line segments linked by a relatively sharp “knee”. “Blank” runs are used to determine the pressure/temperature curve for water not including gas hydrate inhibitors under equilibrium conditions; at pressures corresponding to the “knee” for runs including gas hydrate inhibitors, the “blank” plot is well to the low temperature side of the “knee”. The sub-cooling value is assessed as the temperature difference at constant pressure between the test run for a candidate inhibitor and the “blank” run. Replicates are usually run to improve the measurement precision.

### SYNTHESIS EXAMPLES

### Synthesis Example SE1

### Poly(dimethylaminoethylmethacrylate-co-methacrylamide)

Methacrylamide (10.6 g; 0.125 mol) and AMBN (20 g) were dissolved in dimethylaminoethylmethacrylate (389.4 g, 2.49 mol) at ambient temperature. This fresh solution was then pump-fed into stirred 2-butoxyethanol (600 g) at 110° C. over a two hour period and the mixture held at 110° C. for a further hour before being cooled and decanted to yield the desired product as a viscous, yellow liquid at above 99.5% yield. The residual free monomer levels of the product co-polymer was measured and the copolymer composition and yield inferred from the free monomers level. The copolymer molecular weight was assessed as described above and the final solvent level was measured by gas chromatography.

### Examples SE2 and SE3

Further similar copolymers were made by this method by substituting the corresponding monomers in the desired proportions. The properties of the polymers obtained (including the product of SE1) are set out in Table 1 below.

TABLE 1

| Ex | Monomers | | | Mol Wt | | Resid. |
|---|---|---|---|---|---|---|
| No | AmAc | AcM | mol ratio | (Mₙ) | PDi | AmAc (%) |
| SE1 | AmAc1 | AcM2 | 20:1 | 3910 | 2.07 | 0.80 |
| SE2.1 | AmAc1 | AcM3 | 20:1 | — | — | 0.70 |
| SE2.2 | AmAc1 | AcM3 | 30:1 | 3353 | 2.11 | 0.80 |
| SE2.C | AmAc1 | AcM3 | 1:9 | 2513 | 2.10 | 0.90 |
| SE3 | AmAc1 | AcM1 | 20:1 | 3203 | 2.13 | 0.70 |
| SE3.C | AmAc1 | AcM1 | 1:9 | — | — | — |

### Applications Examples

The ability of copolymers of the invention to inhibit the formation of gas hydrates was tested as described above. The results of this testing are set out in Table 2 below.

TABLE 2

| Ex | Monomers | | | Subcooling | |
|---|---|---|---|---|---|
| No | AmAc | AcM | mol ratio | mean (° C.) | Std Dev |
| SE1 | AmAc1 | AcM2 | 20:1 | 8.9 | 1.2 |
| SE2.1 | AmAc1 | AcM3 | 20:1 | 10.9 | 0.6 |
| SE2.2 | AmAc1 | AcM3 | 30:1 | 8.1 | 1.1 |
| SE2.C | AmAc1 | AcM3 | 1:9 | 8.3 | 1.4 |
| SE3 | AmAc1 | AcM1 | 20:1 | 7.4 | 2.4 |
| SE3.C | AmAc1 | AcM1 | 1:9 | 5.5 | 1.2 |

1. A gas hydrate treatment material which comprises a copolymer of at least one aminoester or aminoamide of (meth)acrylic acid and at least one (meth)acrylamide in which the residues of the (meth)acrylamide(s) are present at a molar ratio of from 10:1 to 60:1.

2. A gas hydrate treatment material as claimed in claim 1 wherein the aminoester or aminoamide of (meth)acrylic acid is a Nalkylamino(ester or amide) of (meth)acrylic acid.

3. A gas hydrate treatment material as claimed in claim 1 wherein the aminoester or aminoamide of (meth)acrylic acid is of the formula (I):
H₂C═CR¹C(O)XR²NR³R⁴ (I)
where
R¹ is H or methyl;
R² is a C₁ to C₁₀ hydrocarbyl group;
R³ is H or a C₁ to C₁₀ n hydrocarbyl group;
R⁴ C₁ to C₁₀ o hydrocarbyl group; or
R³ and R⁴ together with the N atom to which they are attached form a 5-, 6- or 7-membered heterocyclic ring; and
X is —O— or —NR5-, where R⁵ is H or a C₁ to C₁₀ hydrocarbyl group; and
the (meth)acrylamide is of the formula (II):
H₂C═CR⁶C(O)NR⁷R⁸ (II)
where
R⁶ is H or methyl;
R⁷ and R⁸ are each independently H or a C₁ to C₁₀ hydrocarbyl group or
R³ and R⁴ together with the N atom to which they are attached form a 5-, 6- or 7-membered heterocyclic ring.

4. A gas hydrate treatment material as claimed in claim 3 wherein the aminoester is a monomer of the formula (Ia):
H₂C═CR¹C(O)OR²NR³R⁴ (Ia)
where R′, R², R³ and R⁴ are as defined in claim 3.

5. A gas hydrate treatment material as claimed in claim 3 wherein the aminoamide is a monomer of the formula (Ib):
H₂C═CR¹C(O)NRS—R²NR³R⁴ (Ib)
where R¹, R², R³ R⁴ and R⁵ are as defined in claim 3.

6. A gas hydrate treatment material as claimed in claim 3 wherein R² is a C₂ to C₈, particularly a C₂ to C₄ alkylene group; R³ and R⁴ are each C₁ to C₄ alkyl groups, or, where the group —NR³R⁴ is a heterocyclic ring, an N-pyrrolidino, N-piperidino, N-morpholino, N-piperazino or N-caprolactamyl group; R⁵ (when present) is H; and R⁷ and R⁸ are each H or a C₁ to C₄ alkyl group, or, where the group —NR⁷R⁸ is a heterocyclic ring, an N-pyrrolidino, N-piperidino, N-morpholino, N-piperazino or N-caprolactamyl group.

7. A gas hydrate treatment material as claimed in claim 1 wherein the molar ratio of the amino (meth)acrylate or amino (meth)acrylamide and (meth)acrylamide monomers is from 12:1 to 50:1, desirably from 15:1 to 30:1, and especially about 20:1.

8. A gas hydrate treatment material as claimed in claim 1 having an average molecular weight of from 500 to 20000, particularly from 1000 to 10000 and desirably from 1500 to 5000.

9. A gas hydrate treatment material as claimed in claim 1 which is a solution of the copolymer in an alcohol, a glycol or a glycol ether.

10. A gas hydrate treatment material as claimed in claim 1 which includes at least one of a corrosion inhibitor, a wax dispersant, an asphaltene dispersant or a scale inhibitor.

11. A method of treating gas water mixtures which are susceptible to the formation of gas hydrates with a hydrate inhibiting amount of a copolymer of at least one aminoester of (meth)acrylic acid and at least one (meth)acrylamide in which the residues of the (meth)acrylamide(s) are present at a molar ratio of from 10:1 to 60:1.
